(19) United States
(12) Patent Application Publication
(10) Pub. No.: US 2025/0010806 A1
(43) Pub. Date: Jan. 9, 2025

(54) Dump Liner System

(71) Applicant: Glenn Fuerstenberg, Sioux Falls, SD (US)

(72) Inventor: Glenn Fuerstenberg, Sioux Falls, SD (US)

(21) Appl. No.: 18/804,590

(22) Filed: Aug. 14, 2024

Related U.S. Application Data
(63) Continuation-in-part of application No. 18/382,416, filed on Oct. 20, 2023.
Application No. 18/382,416 is a continuation-in-part of application No. 18/218,862, filed on Jul. 6, 2023.

(51) Int. Cl. B60R 13/01

(52) U.S. Cl. CPC B60R 13/01; B60R 2013/016

(57) ABSTRACT

A dump liner system includes a bucket which may contain a substance when positioned in a holding position such that a concave interior surface of the bucket faces generally upwardly. The bucket may be turned in either of a first rotational direction or an opposing second rotational direction to dump the substance. A flexible panel is mounted in the bucket and acts as a liner which conforms to the concave interior surface of the bucket when the bucket is in the holding position. The flexible panel is tethered to the bucket but otherwise free to move. The flexible panel falls out of the bucket via 10 gravity when the bucket dumps the substance contained therein, which helps facilitate removal of the substance which would otherwise stick to the concave interior substance.

### CROSS-REFERENCE TO RELATED APPLICATIONS

This application is a continuation-in-part of U.S. patent application Ser. No. 18/382,416 filed Oct. 20, 2023, which is a continuation-in-part of U.S. patent application Ser. No. 18/218,862 filed Jul. 6, 2023. I hereby claim benefit under 35 U.S.C., Section 120 to each of the above listed patent applications.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to dump devices and more particularly pertains to a new dump device for promoting fully emptying of a bucket and preventing debris buildup with the bucket.

### (2) Description of Related Art including information disclosed under 37 CFR 1.97 and 1.98.

The prior art relates to dump devices such as a bucket for a backhoe. Known prior art lacks a liner attached to the bucket or tub to prevent retention or buildup of debris in the bucket.

### BRIEF SUMMARY OF THE INVENTION

An embodiment of the disclosure meets the needs presented above by generally comprising a bucket which has a first side, a second side, and a concave interior surface which extends between the first side and the second side. The bucket is positionable in a holding position in which the concave interior surface faces upwardly, which facilitates the bucket in holding a load. The bucket is also rotatable in either of a pair of opposing rotational directions to dump the load. In a first dumping position, the first side is positioned above the second side, while the second side is positioned above the first side in a second dumping position.

A panel is mounted in the bucket. The panel has a first loose connection edge, a second loose connection edge, and a lining surface which extends between the first and second loose connection edges. The panel is unconnected to the bucket between the first and second loose connection edges such that the panel falls away from the concave interior surface of the bucket when the bucket is moved into either of the first and second dumping positions. The first and second loose connection edges are movably coupled to the bucket. The panel is flexible such that the panel extends into and conforms to the concave interior surface of the bucket when the bucket is in the holding position.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a dump liner system according to an embodiment of the disclosure.

FIG. 2 is a perspective view of an embodiment of the disclosure.

FIG. 3 is a top view of an embodiment of the disclosure.

FIG. 4 is a cross section view of an embodiment of the disclosure taken from Line 4-4 in FIG. 3.

FIG. 5 is a rear view of an embodiment of the disclosure.

FIG. 6 is a rear view of an embodiment of the disclosure in which a bucket is positioned in a second dumping position to dump a substance out from the bucket.

FIG. 7 is a rear view of an embodiment of the disclosure in which a bucket is positioned in a first dumping position to dump a substance out from the bucket.

FIG. 8 is a perspective view of an embodiment of the disclosure.

FIG. 9 is a top view of an embodiment of the disclosure.

FIG. 10 is a top view of an embodiment of the disclosure.

FIG. 11 is a cross section view of an embodiment of the disclosure.

### DETAILED DESCRIPTION OF THE INVENTION

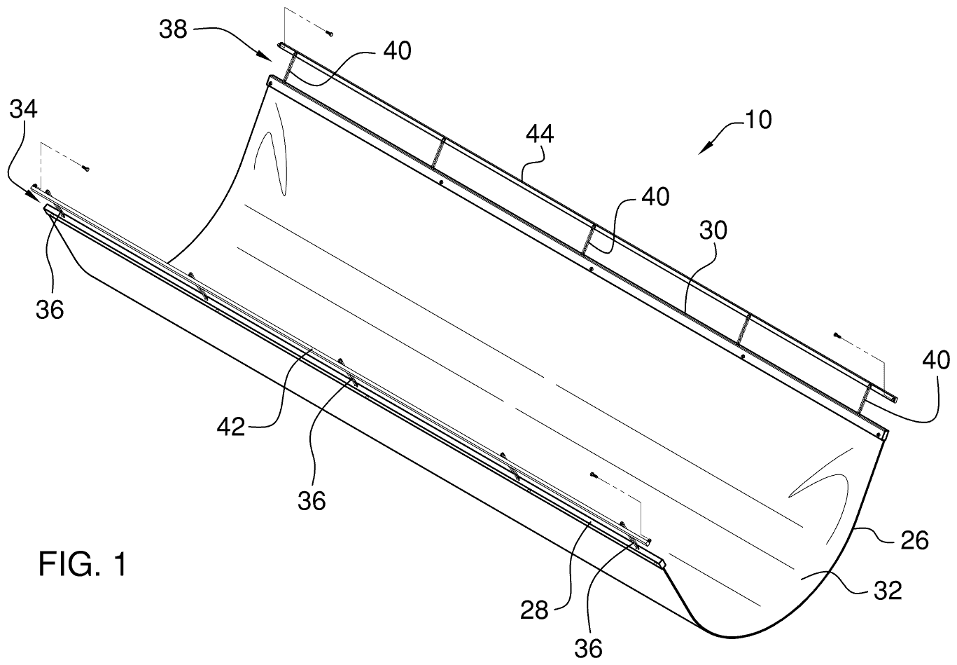

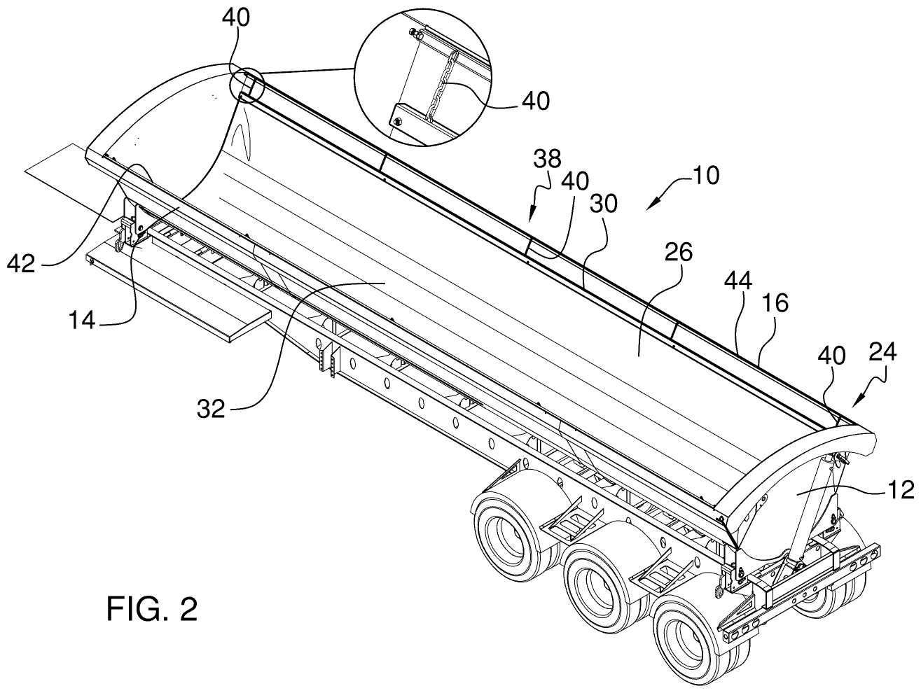

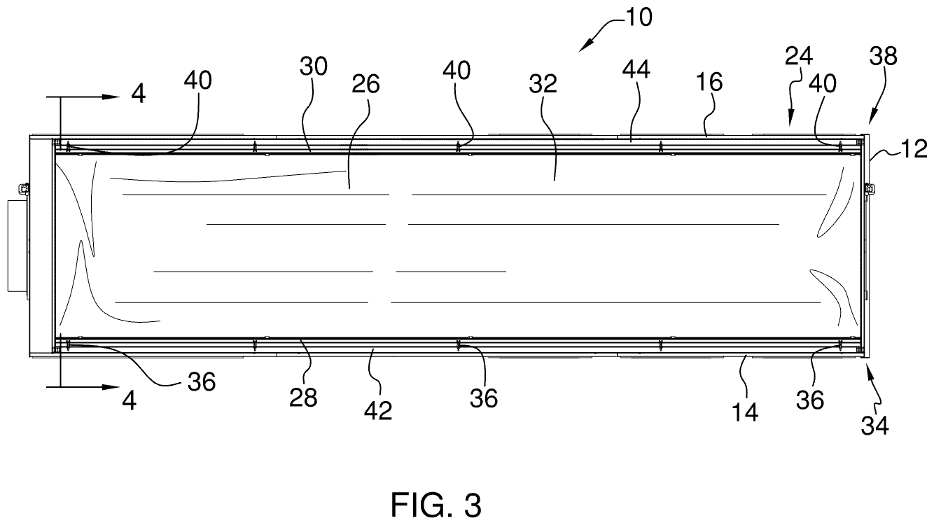

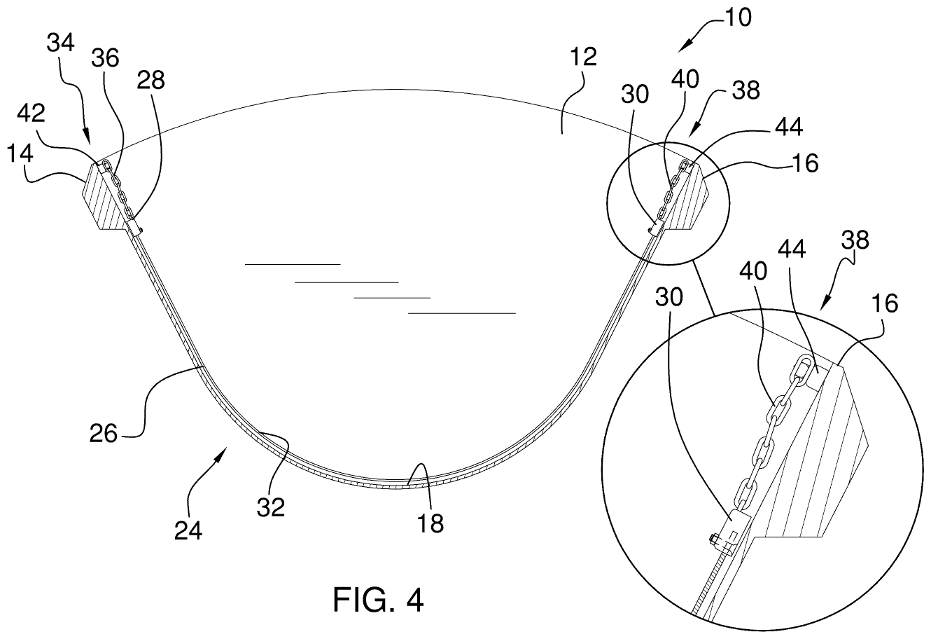

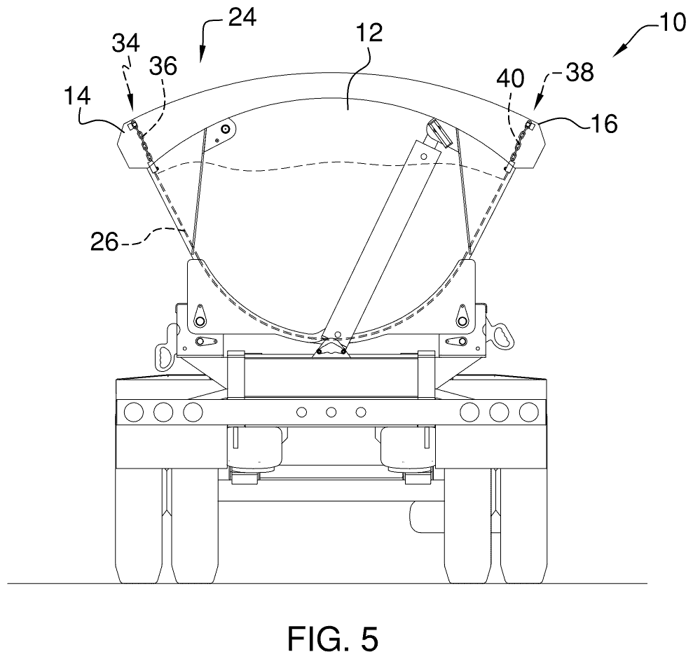

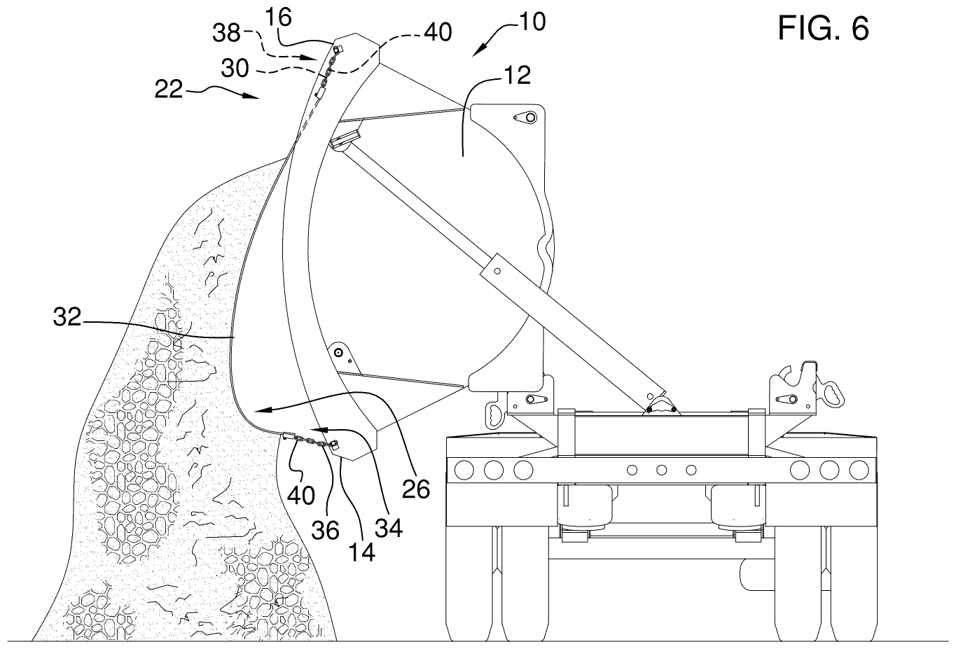

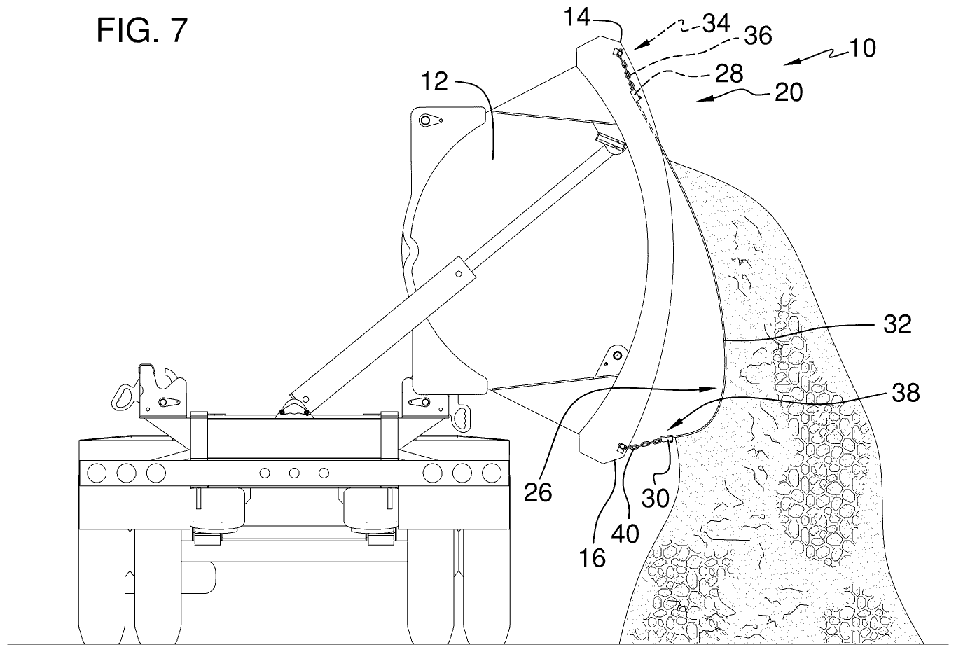

With reference now to the drawings, and in particular to FIGS. 1 through 11 thereof, a new dump device embodying the principles and concepts of an embodiment of the disclosure and generally designated by the reference numeral 10 will be described.

As best illustrated in FIGS. 1 through 11, the dump liner system 10 generally comprises a bucket 12 which has a first side 14 and a second side 16 and has a concave interior surface 18 that extends between the first side 14 and the second side 16. The bucket 12 may be positioned in a holding position 24 in which the concave interior surface 18 faces upwardly, which allows for a load to be carried in the bucket 12. The bucket 12 may also be turned one of two opposing rotational directions to dump the load. In a first dumping position 20 the first side 14 is positioned above the second side 16, while in a second dumping position 22 the second side 16 is positioned above the first side 14. The bucket 12 may be part of a construction vehicle such as a dump truck. In particular, the bucket 12 may be part of a side dump truck which carries the bucket 12 on a trailer and is configured to dump the bucket 12 selectively left or right with respect to the side dump truck.

A panel 26 is mounted in the bucket 12 and is flexible such that it extends into and conforms to the concave interior surface 18 of the bucket 12, extending between the first side 14 and the second side 16, when the bucket 12 is in the holding position 24. The panel 26 has a first loose connection edge 28, a second loose connection edge 30, and a lining surface 32 which extends between the first and second loose connection edges 28, 30. The panel 26 is unconnected to the bucket 12 between the first and second loose connection edges 28, 30 such that, when the bucket 12 is positioned in either the first dumping position 20 or the second dumping position 22, gravity urges the panel 26 away from the concave interior surface 18 of the bucket 12. The first loose connection edge 28 and the second loose connection edge 30 are movably coupled to the bucket 12 such that the panel 26 may move away from the concave interior surface 18 of the bucket 12 as described. The panel 26 may be constructed of rubber or other suitably flexible material. In particular, a flexible material may be chosen which is durable to withstand forces from loads and which is resistant to damage from temperature changes resulting from hot or cold environments or loads.

A first restraint assembly 34 and a first beam 42 couple the first loose connection edge 28 of the panel 26 to the bucket 12, while a second restraint assembly 38 and a second beam 44 couple the second loose connection edge 30 of the panel 26 to the bucket 12. The first beam 42 is coupled to the bucket 12 proximate to the first side 14 and extends generally parallel to the first side 14. The first restraint assembly 34 comprises a plurality of first tethers 36, each of which extends between the first beam 42 and the first loose connection edge 28 of the panel 26. The second beam 44 is coupled to the bucket 12 proximate to the second side 16 and extends generally parallel to the second side 16. The second restraint assembly 38 comprises a plurality of second tethers 40, each of which extends between the second beam 44 and the second loose connection edge 30 of the panel 26. The first tethers 36 and second tethers 40 comprise chains but may comprise ropes, cables, or the like.

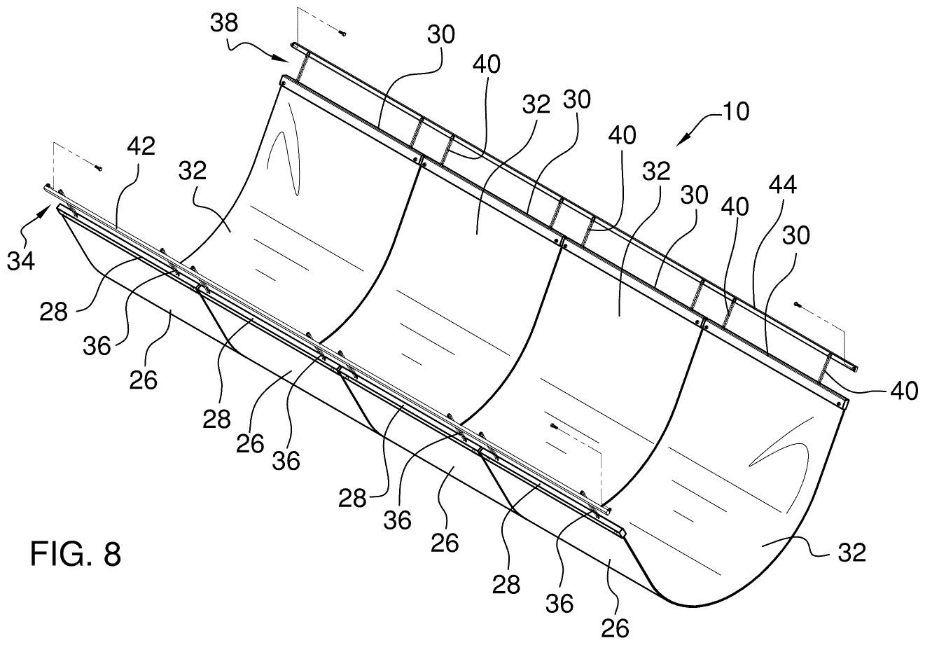

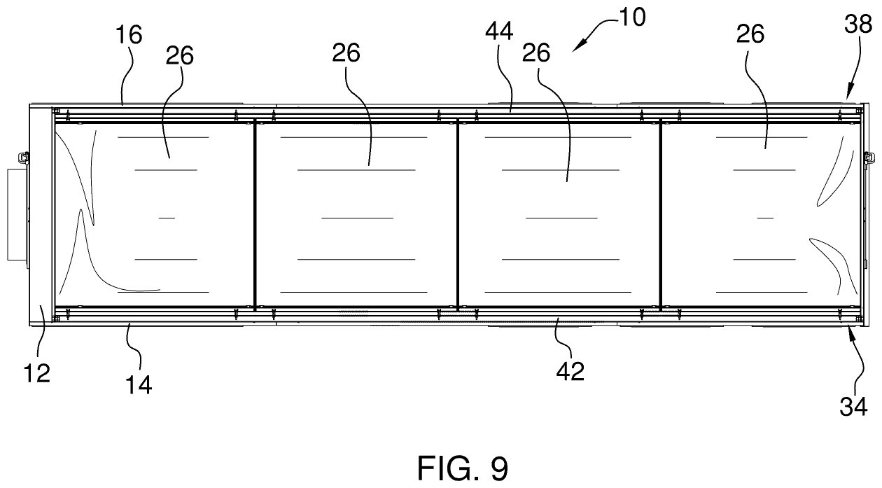

With reference to FIGS. 8 and 9, several panels 26 may be coupled to the bucket 12 and arranged in a linear manner along the bucket 12 in a direction generally parallel to the first side 14 and to the second side 16. The first restraint assembly 34 may couple the first loose connection edge 28 of each panel 26 to the bucket 12 and the second restraint assembly 38 may couple the second loose connection edge 30 of each panel 26 to the bucket 12 in such embodiments.

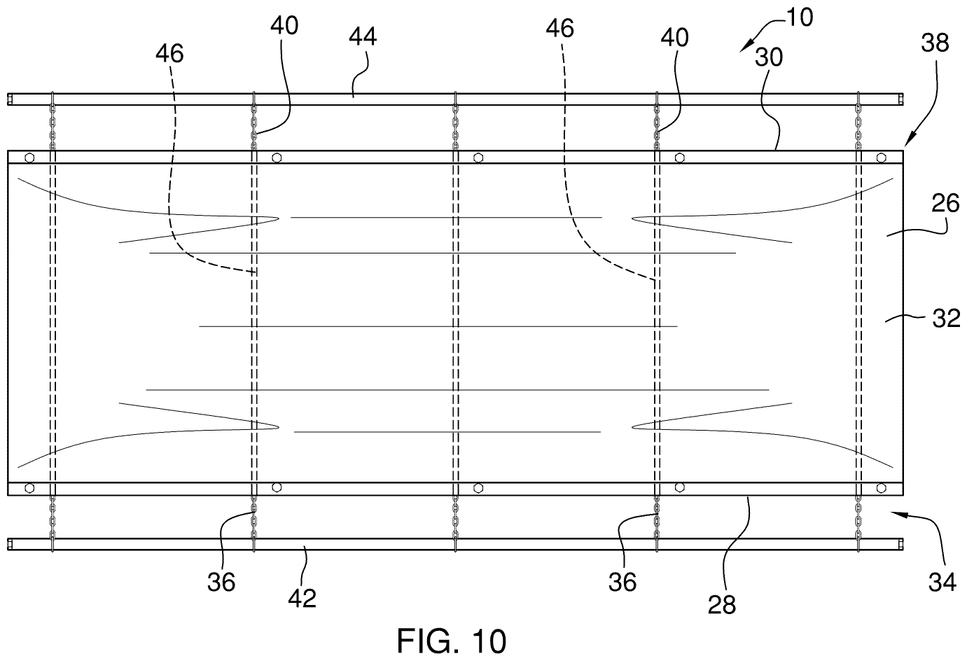

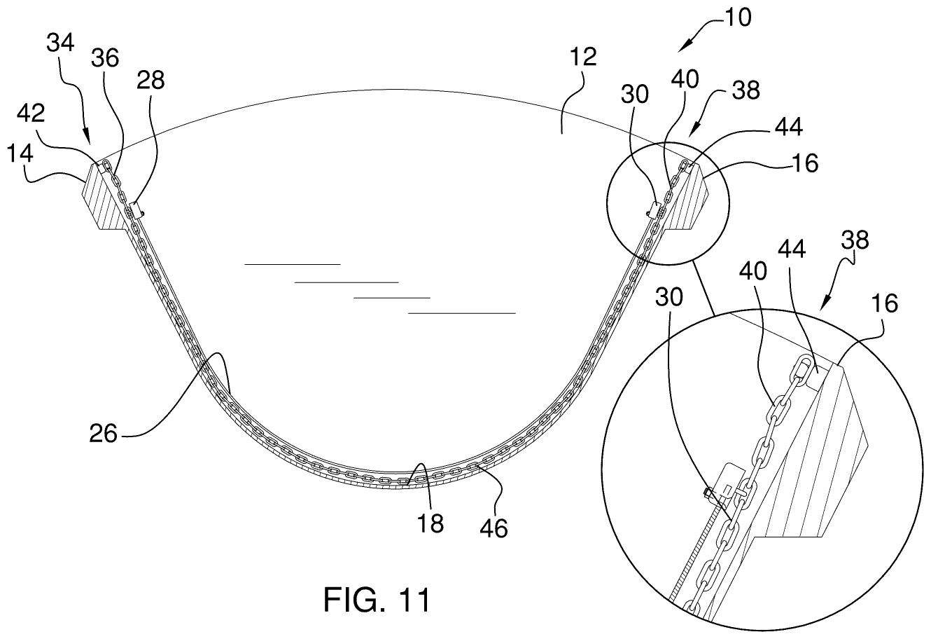

FIGS. 10 and 11 depict an embodiment in which each first tether 36 is joined to an associated second tether 40 of the plurality of second tethers 40 by an intermediate tether 46 which extends underneath the panel 26. Each first tether 36 and associated second tether 40 and intermediate tether 46 is integrally formed of a chain, the links of which are made to vibrate under external forces, such as those experienced when driving a vehicle over a road or other surface equipped with the bucket 12. The vibrations of the chain links help to break up and dislodge debris such as ice which builds up underneath the panel 26 and causes it to adhere to the bucket 12. Other flexible members may be used to impart vibrations on the debris and attach the panel 26 to the bucket 12, including cables, ropes, or the like. In other embodiments, other vibration members separate from the first tethers 36 and the second tethers 40 may be used which are free to move between the panel 26 and the bucket 12. This freedom of movement may be used to impart the vibratory forces experienced from driving the vehicle or other sources.

In use, the bucket 12 is filled with various loads which may be dumped out by positioning the bucket 12 in either of the first and second dumping positions 20, 22. Substances which would otherwise stick to the bucket 12 pull on the panel 26 when the bucket 12 is turned to dump, which causes the panel 26 and the substances to freely drop away from the bucket 12. The momentum from the substances dropping away from the bucket 12 then enables them to break free from the panel 26. In some cases, the panel 26 may not fall due to its own weight and may require an adherent substance with sufficient weight to cause the panel 26 and the adherent substance to fall away from the bucket 12. Especially in such cases, multiple panels 26 such as those shown in the embodiment of FIGS. 8 and 9 may be beneficial. If a load is positioned only in a certain space within the bucket 12, only the panel 26 or panels 26 in that certain space would need to be made to fall away from the bucket 12. The chains or other vibration members operate to dislodge ice and other debris as described above.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A dump liner system comprising:
a bucket having a first side and a second side, the bucket having a concave interior surface extending between the first side and the second side wherein the bucket is configured for holding material in the bucket when the bucket is in a holding position, the bucket being positionable in a first dumping position in which the first side is positioned above the second side, the bucket being positionable in a second dumping position in which the second side is positioned above the first side; and
a panel having a first loose connection edge and a second loose connection edge, the panel having a lining surface extending between the first and second loose connection edges, each of the first and second loose connection edges being movably coupled to the bucket, the panel being flexible whereby the panel extends into and conforms to the concave interior surface of the bucket extending between the first side and the second side when the bucket is the holding position, the panel being unconnected to the bucket between the first and second loose connection edges wherein the panel is gravitationally urged away from the concave interior surface of the bucket when the bucket is moved into either of the first and second dumping positions.

2. The dump liner system of claim 1, wherein the panel is constructed of rubber.

3. The dump liner system of claim 1, further comprising a first restraint assembly and a second restraint assembly coupled to the panel and the bucket, the first restraint assembly coupling the first loose connection edge of the panel to the bucket proximate the first side, the second restraint assembly coupling the second loose connection edge of the panel to the bucket proximate the second side.

4. The dump liner system of claim 3, wherein the first restraint assembly comprises a plurality of first tethers, each first tether of the plurality of first tethers extending from the first loose connection edge of the panel toward the first side of the bucket, the second restraint assembly comprising a plurality of second tethers, each second tether of the plurality of second tethers extending from the second loose connection edge of the panel toward the second side of the bucket.

5. The dump liner system of claim 4, further comprising:
a first beam coupled to the bucket proximate to and extending generally parallel to the first side of the bucket, the first beam coupling the first restraint assembly to the bucket, each first tether of the plurality of tethers being coupled to the first beam; and
a second beam coupled to the bucket proximate to and extending generally parallel to the second side of the bucket, the second beam coupling the second restraint assembly to the bucket, each second tether of the plurality of tethers being coupled to the second beam.

6. The dump liner system of claim 1, wherein:
the panel is one of a plurality of panels, the plurality of panels being arranged linearly along the first and second sides of the bucket, each panel of the plurality of panels having a first loose connection edge and a second loose connection edge, each panel having a lining surface extending between the first and second loose connection edges, each of the first and second loose connection edges of each panel being movably coupled to the bucket, each panel being flexible whereby the panel extends into and conforms to the concave interior surface of the bucket extending between the first side and the second side when the bucket is the holding position, each panel being unconnected to the bucket between the first and second loose connection edges wherein the panel is gravitationally urged away from the concave interior surface of the bucket when the bucket is moved into either of the first and second dumping positions.

7. The dump liner system of claim 6, wherein each panel is constructed of rubber.

8. The dump liner system of claim 6, further comprising a first restraint assembly and a second restraint assembly coupled to the plurality of panels and the bucket, the first restraint assembly coupling the first loose connection edge of each panel to the bucket proximate the first side, the second loose connection edge of each panel to the bucket proximate the second side.

9. The dump liner system of claim 1, further comprising a plurality of vibration members coupled to the panel, the plurality of vibration members being positioned between the panel and the bucket, each vibration member of the plurality of vibration members being configured to vibrate to dislodge debris.

10. The dump liner system of claim 9, wherein each vibration member is freely movable between the panel and the bucket.

11. The dump liner system of claim 9, wherein each vibration member is coupled to and extends between an associated first tether of the plurality of first tethers and an associated second tether of the plurality of second tethers.

12. The dump liner system of claim 11, wherein each vibration member is integrally formed with the associated first tether and the associated second tether, each vibration member and its associated first tether and associated second tether comprising a chain.

13. A dump liner system comprising:
a bucket having a first side and a second side, the bucket having a concave interior surface extending between the first side and the second side wherein the bucket is configured for holding material in the bucket when the bucket is in a holding position, the bucket being positionable in a first dumping position in which the first side is positioned above the second side, the bucket being positionable in a second dumping position in which the second side is positioned above the first side;
a panel having a first loose connection edge and a second loose connection edge, the panel having a lining surface extending between the first and second loose connection edges, each of the first and second loose connection edges being movably coupled to the bucket, the panel being flexible whereby the panel extends into and conforms to the concave interior surface of the bucket extending between the first side and the second side when the bucket is the holding position, the panel being unconnected to the bucket between the first and second loose connection edges wherein the panel is gravitationally urged away from the concave interior surface of the bucket when the bucket is moved into either of the first and second dumping positions, the panel being constructed of rubber;
a first restraint assembly and a second restraint assembly coupled to the panel and the bucket, the first restraint assembly coupling the first loose connection edge of the panel to the bucket proximate the first side, the second restraint assembly coupling the second loose connection edge of the panel to the bucket proximate the second side, the first restraint assembly comprising a plurality of first tethers, each first tether of the plurality of first tethers extending from the first loose connection edge of the panel toward the first side of the bucket, the second restraint assembly comprising a plurality of second tethers, each second tether of the plurality of second tethers extending from the second loose connection edge of the panel toward the second side of the bucket;
a first beam coupled to the bucket proximate to and extending generally parallel to the first side of the bucket, the first beam coupling the first restraint assembly to the bucket, each first tether of the plurality of tethers being coupled to the first beam; and
a second beam coupled to the bucket proximate to and extending generally parallel to the second side of the bucket, the second beam coupling the second restraint assembly to the bucket, each second tether of the plurality of tethers being coupled to the second beam.

14. The dump liner system of claim 13, wherein:
the panel is one of a plurality of panels, the plurality of panels being arranged linearly along the first and second sides of the bucket, each panel of the plurality of panels having a first loose connection edge and a second loose connection edge, each panel having a lining surface extending between the first and second loose connection edges, each of the first and second loose connection edges of each panel being movably coupled to the bucket, each panel being flexible whereby the panel extends into and conforms to the concave interior surface of the bucket extending between the first side and the second side when the bucket is the holding position, each panel being unconnected to the bucket between the first and second loose connection edges wherein the panel is gravitationally urged away from the concave interior surface of the bucket when the bucket is moved into either of the first and second dumping positions, each panel being constructed of rubber; and
the first restraint assembly and the second restraint assembly couple each panel of the plurality of panels to the bucket, the first restraint assembly coupling the first loose connection edge of each panel to the bucket proximate the first side, the second loose connection edge of each panel to the bucket proximate the second side.

15. The dump liner system of claim 13, further comprising a plurality of vibration members coupled to the panel, the plurality of vibration members being positioned between the panel and the bucket, each vibration member of the plurality of vibration members being configured to vibrate to dislodge debris, each vibration member being freely movable between the panel and the bucket, each vibration member being coupled to and extending between an associated first tether of the plurality of first tethers and an associated second tether of the plurality of second tethers, each vibration member being integrally formed with the associated first tether and the associated second tether, each vibration member and its associated first tether and associated second tether comprising a chain.
